(19) United States
(12) Patent Application Publication
(10) Pub. No.: US 2026/0260999 A1
(43) Pub. Date: Sep. 3, 2026

(54) Battery Pack

(71) Applicant: SK On Co., Ltd., Seoul (KR)

(72) Inventor: Jeong Woo HAN, Daejeon (KR)

(21) Appl. No.: 19/531,908

(22) Filed: Feb. 6, 2026

(30) Foreign Application Priority Data
Feb. 28, 2025 (KR) 10-2025-0026889

(51) Int. Cl. H01M 50/271; H01M 50/204; H01M 50/264; H01M 50/293

(52) U.S. Cl. CPC H01M 50/271; H01M 50/204; H01M 50/264; H01M 50/293; H01M 2220/20

(57) ABSTRACT

A battery pack includes at least one battery module including a plurality of sub-modules and a top cover covering the plurality of sub-modules, the plurality of sub-modules each including a plurality of battery cells, a pack housing in which the at least one battery module is installed, and a pressing member pressing an upper portion of the top cover and coupled to the pack housing. The top cover includes a boundary region covering a gap between adjacent sub-modules, and the pressing member is structured to press the top cover above the boundary region.

### CROSS-REFERENCE TO RELATED APPLICATION(S)

This patent document claims the priority and benefits of Korean Patent Application No. 10-2025-0026889 filed on Feb. 28, 2025, the disclosure of which is incorporated herein by reference in its entirety.

### TECHNICAL FIELD

The disclosure and implementations disclosed in this patent document generally relate to a battery pack including a plurality of battery cells (secondary batteries) capable of being charged and discharged.

### BACKGROUND

Battery cells (secondary batteries) offer the convenience of rechargeability, unlike primary batteries, and are attracting significant attention as a power source for various mobile devices and electric vehicles.

A battery cell may include an electrode assembly and a cell case housing the electrode assembly. The electrode assembly may be formed by stacking a cathode, an anode, and a separator or by winding the same into a roll shape, and then housed within the cell case.

A plurality of battery cells may be arranged in a predetermined direction to form a cell assembly. The cell assembly may be housed in a battery module and/or battery pack.

### SUMMARY

Battery cells may experience thermal runaway, which involves the generation of gas and/or flames, due to internal shorts, overcharging, and other causes. In this case, a flame may develop in a cell assembly containing the battery cell, and the flame may spread to adjacent cell assemblies, resulting in thermal propagation.

For example, a cell assembly may constitute a battery module or sub-module, and thermal runaway occurring in one battery module or sub-module may spread to adjacent battery modules or sub-modules, resulting in thermal propagation. Therefore, there is a need to delay or prevent the spread of flames originating in a battery module (or sub-module) to adjacent battery modules (or sub-modules) as much as possible.

The present disclosure may be implemented in some embodiments to provide a battery pack that may delay or significantly reduce the propagation of thermal runaway occurring in any one sub-module including a plurality of battery cells to adjacent sub-modules.

According to an aspect of the present disclosure, a battery pack may be provided in which the spread of a fire originating in one battery module to an adjacent battery module may be delayed or significantly reduced.

The battery pack in the present disclosure may be widely applied to devices within green technology fields such as electric vehicles, battery charging stations, and other battery-powered solar and wind power generation. Furthermore, the battery pack according to an embodiment of the present disclosure may be used in eco-friendly electric vehicles, hybrid vehicles, and other products that aim to prevent climate change by suppressing air pollution and greenhouse gas emissions.

In some embodiments of the present disclosure, a battery pack includes at least one battery module including a plurality of sub-modules and a top cover covering the plurality of sub-modules, the plurality of sub-modules each including a plurality of battery cells; a pack housing in which the at least one battery module is installed; and a pressing member pressing an upper portion of the top cover and coupled to the pack housing. The top cover includes a boundary region covering a gap between adjacent sub-modules, and the pressing member is structured to press the top cover above the boundary region.

In an embodiment, the top cover may have an area capable of covering the plurality of sub-modules together.

In an embodiment, the plurality of sub-modules may include a first sub-module and a second sub-module, the top cover may further include a first region covering the first sub-module and a second region covering the second sub-module, and the boundary region may be located between the first region and the second region.

In an embodiment, the first region, the second region, and the boundary region of the pressing member may be formed integrally.

In an embodiment, the pack housing may include a base plate disposed below the at least one battery module, and a cross member disposed opposite a side surface of the at least one battery module, and the pressing member may be coupled to the cross member.

In an embodiment, the pressing member may include a pressing portion covering the top cover, an extension portion bent from both ends of the pressing portion and extending downward, and a support portion connected to the extension portion and supported by the cross member.

In an embodiment, each of the plurality of sub-modules may include a cell assembly in which a plurality of battery cells are arranged, and a side plate protecting a side surface of the cell assembly. The side plate may include a module fastening portion extending from a side surface of the side plate and fixed to the cross member. The support portion may be fixed to the cross member above the module fastening portion.

In an embodiment, the support portion may be fixed to the cross member by a fixing member that penetrates the support portion and the module fastening portion and then be fastened to the cross member.

In an embodiment, a width of the extension portion may have a value greater than or equal to a maximum value of a width of the pressing portion.

In an embodiment, the pressing portion may include a first portion located at a center of the pressing portion and a second portion respectively located on both sides of the first portion and connected to the extension portion. A width of the second portion may have a value greater than a width of the first portion.

In an embodiment, a thickness of the pressing member may have a value greater than or equal to a thickness of the top cover.

In an embodiment, the pressing member may include a pressing portion disposed above the top cover, and a compressible member attached to a lower side of the pressing portion and including a compressible material. The compressible member may be compressed between the pressing portion and the top cover.

In an embodiment, a material of the compressible member may include at least one of synthetic rubber, silicone, flame-retardant foam, aerogel foam, silica foam, or mica foam.

In an embodiment, the pressing member may include a rigid reinforcing structure having a concave-convex portion to increase rigidity of the pressing member.

In an embodiment, the at least one battery module may include a plurality of battery modules, and the pressing member may cover top covers provided in the plurality of battery modules together.

In an embodiment, each of the plurality of sub-modules may include a cell assembly in which a plurality of battery cells are arranged and a side plate protecting a side surface of the cell assembly, and the pack housing may include a base plate disposed below the plurality of battery modules, a pack cover covering the plurality of battery modules, and a cross member disposed between adjacent battery modules. The cross member may be disposed on the base plate while being coupled to each battery module.

In an embodiment, the side plate may include a module fastening portion extending from a side surface of the side plate and coupled to the cross member, and the cross member may include a first cross member disposed below the module fastening portion and supporting the module fastening portion, and a second cross member disposed above the module fastening portion.

In an embodiment, the first cross member may be disposed opposite a side plate positioned on a first side of each battery module, and the second cross member may be disposed opposite a side plate positioned on a second side of each battery module.

In an embodiment, the second cross member, the module fastening portion, and the first cross member may be disposed vertically between the pressing member and the base plate, and the pressing member may be structured to press the second cross member, between adjacent battery modules.

In some embodiments of the present disclosure, a battery pack includes at least one battery module including a first sub-module and a second sub-module each including a plurality of battery cells, and a top cover covering the first sub-module and the second sub-module together; a pack housing in which the at least one battery module is installed; and a pressing member pressing an upper portion of the top cover and coupled to the pack housing. The top cover includes a first region covering the first sub-module and a second region covering the second sub-module, and the pressing member is located in a position transversing a space between the first region and the second regions and pressing the top cover.

### BRIEF DESCRIPTION OF DRAWINGS

Certain aspects, features, and advantages of the present disclosure are illustrated by the following detailed description with reference to the accompanying drawings.

FIG. 1 is a perspective view illustrating a battery pack according to an embodiment.

FIG. 2 is a perspective view of the battery module illustrated in FIG. 1.

FIG. 3 is an exploded perspective view of the battery module illustrated in FIG. 2.

FIG. 4 is an exploded perspective view of a sub-module illustrated in FIG. 3.

FIG. 5 is a cross-sectional view taken along line I-I’ of FIG. 2.

FIG. 6 is a perspective view illustrating a portion of a battery pack according to an embodiment.

FIG. 7 is a perspective view of a pressing member according to an embodiment.

FIG. 8 is a cross-sectional view taken along line II-II’ of FIG. 6.

FIG. 9 is a cross-sectional view illustrating a modified embodiment of the pressing member.

FIG. 10 is a perspective view of the pressing member illustrated in FIG. 9 as viewed from below.

FIG. 11 is a cross-sectional view taken along line II-II’ of FIG. 6, illustrating a structure in which the pressing member illustrated in FIG. 9 is disposed.

FIG. 12 is a cross-sectional view illustrating another modified embodiment of a pressing member.

FIG. 13 is a plan view illustrating a portion of a battery pack according to another embodiment.

FIG. 14 is a front view of the battery pack of FIG. 13.

FIG. 15 is a schematic diagram illustrating an example of the battery module illustrated in FIG. 13.

### DETAILED DESCRIPTION

Features of the present disclosure disclosed in this patent document are described by example embodiments with reference to the accompanying drawings.

The same reference numbers or symbols in respective drawings attached to this specification indicate parts or components that perform substantially the same functions. For convenience of explanation and understanding, the same reference numbers or symbols may be used in different embodiments. In detail, even if components with the same reference numbers are depicted in multiple drawings, they do not necessarily represent a single embodiment.

In the following description, the singular expression includes plural expressions unless the context clearly indicates otherwise. Terms such as “include” or “compose” indicate the presence of features, numbers, steps, operations, components, parts, or combinations thereof described in the specification, but should be understood as not excluding the possibility of the presence or addition of one or more other features, numbers, steps, operations, components, parts, or combinations thereof.

Furthermore, in the following description, terms such as “upper side,” “upper,” “on,” “lower side,” “lower,” “below,” “side surface,” “front side,” and “rear side” are expressed based on the directions depicted in the drawings, and it should be noted that the expressions may vary depending on the orientation of the corresponding object.

Additionally, terms containing ordinal numbers, such as “first,” “second,” etc., may be used in this specification and claims to distinguish between components. These ordinal numbers are used to distinguish identical or similar components, and the use of these ordinal numbers should not be interpreted as limiting the meaning of the terms. For example, the order of use or arrangement of components associated with these ordinal numbers should not be construed as limited by their numbers. If necessary, respective ordinal numbers may be used interchangeably.

Hereinafter, the present disclosure will be described in detail with reference to the accompanying drawings. However, these are merely examples, and the present disclosure is not limited to the detailed embodiments illustrated herein.

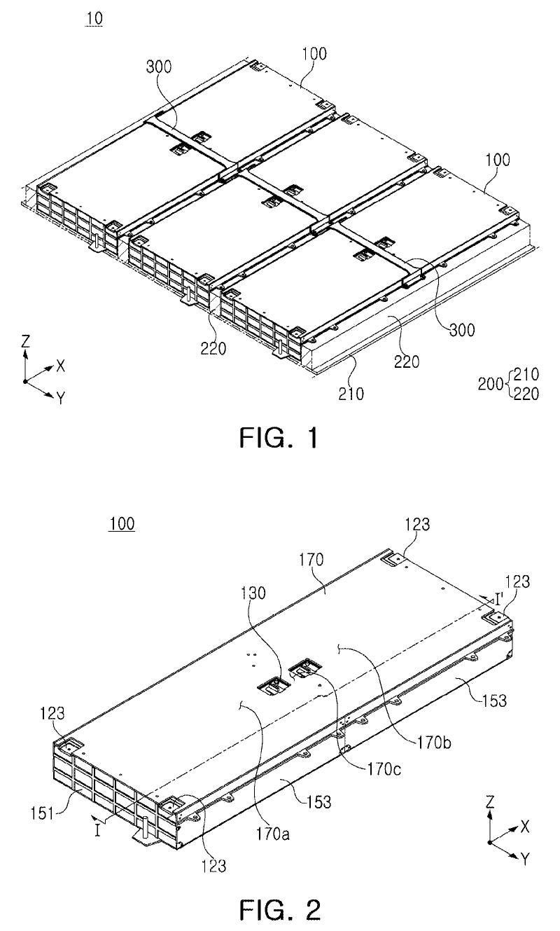

First, a battery pack 10 according to an embodiment will be described with reference to FIGS. 1 to 4.

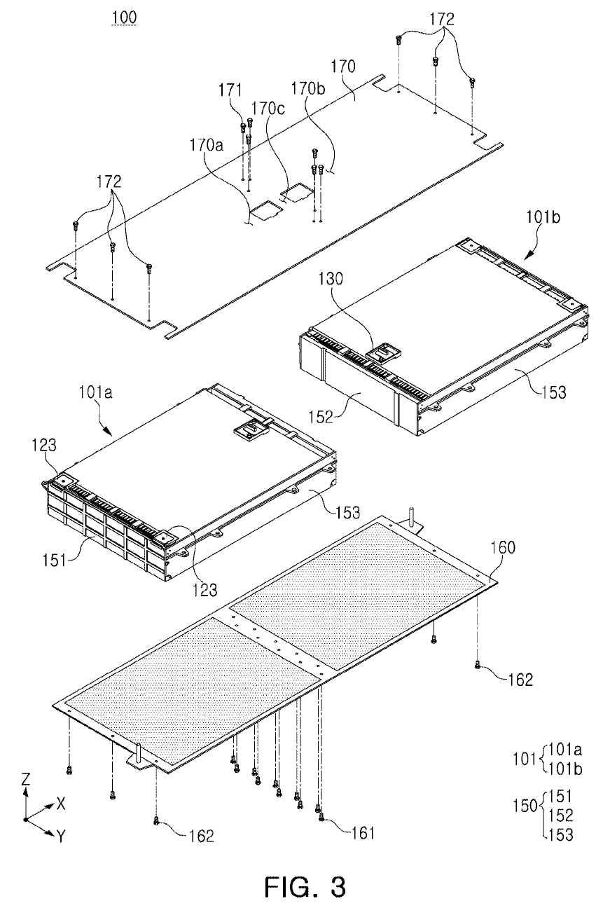

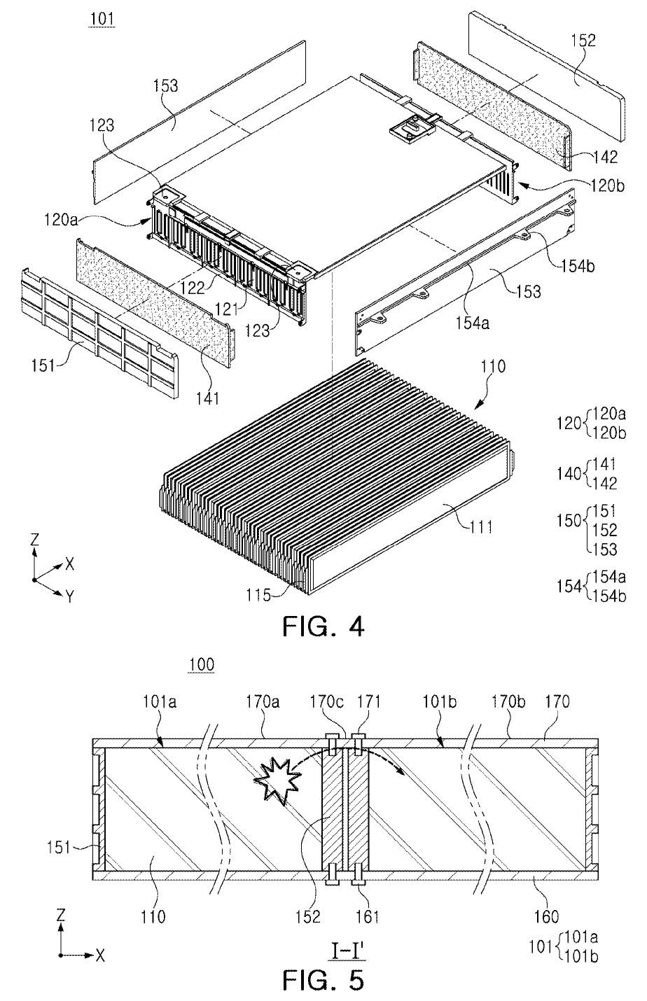

FIG. 1 is a perspective view illustrating a battery pack 10 according to an embodiment, FIG. 2 is a perspective view of a battery module 100 illustrated in FIG. 1, FIG. 3 is an exploded perspective view of the battery module 100 illustrated in FIG. 2, and FIG. 4 is an exploded perspective view of a sub-module 101 illustrated in FIG. 3. FIGS. 1 to 4 merely illustrate the structure and shape of the battery pack 10, the battery module 100, and the sub-module 101, and the detailed shapes of respective components thereof are not limited to the drawings.

Referring to FIGS. 1 to 4, the battery pack 10 according to an embodiment may include at least one battery module 100, a pack housing 200, and a pressing member 300. At least one battery module 100 may include a plurality of sub-modules 101, each of which includes a plurality of battery cells 111, and a top cover 170 covering the plurality of sub-modules 101. A pack housing 200 may have at least one battery module 100 installed therein. The pressing member 300 may pressurize an upper portion of the top cover 170 and may be coupled to the pack housing 200. The top cover 170 may include a boundary region 170c covering a gap between adjacent sub-modules 101. The pressing member 300 may be structured to press the top cover 170 from an upper portion of the boundary region 170c.

At least one battery module 100 may include a first sub-module 101a and a second sub-module 101b, each including a plurality of battery cells 111, and a top cover 170 covering the first sub-module 101a and the second sub-module 101b together. The top cover 170 may include a first region 170a covering the first sub-module 101a and a second region 170b covering the second sub-module 101b. The pressing member 300 may be located in a position transversing the first region 170a and the second region 170b and press the top cover 170.

The battery pack 10 will be described in more detail with reference to FIGS. 1 to 4.

The pack housing 200 may provide a space in which at least one battery module 100 is installed. For example, the pack housing 200 may include a base plate 210 disposed below at least one battery module 100 and a cross member 220 disposed facing a side surface of at least one battery module 100.

The base plate 210 has a plate shape, and the cross member 220 may be disposed above the base plate 210 and arranged along the inner side or edge of the base plate 210. The cross member 220 may include a cross member disposed across the inner side of the base plate 210 and a side wall disposed along the edge or adjacent portion of the base plate 210. The cross member 220 may be coupled and/or secured to the base plate 210. For example, the cross member 220 may be coupled to the base plate 210 using fastening means such as bolts or welding.

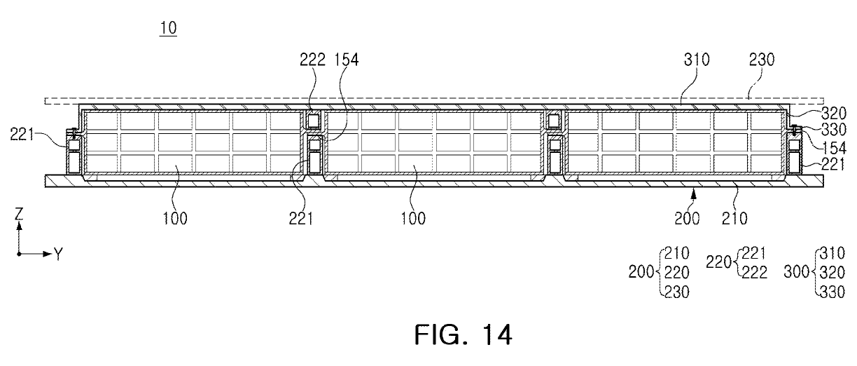

The cross member 220 may be secured to the base plate 210 before the battery module 100 is installed in the pack housing 200, but this is not a limitation. For example, the cross member 220 may be installed to the base plate 210 while still connected to the battery module 100 (see FIGS. 13 to 15).

If the battery pack 10 includes multiple battery modules 100, the cross member 220 may be disposed between the multiple battery modules 100.

The pack housing 200 may additionally include a pack cover (230 in FIG. 14) that covers at least one battery module 100. However, the pack cover 230 may also be replaced with a vehicle floor, or the like.

A battery pack 10 may include at least one battery module 100. While FIG. 1 illustrates a battery pack 10 with three battery modules 100 disposed therein, the battery pack 10 according to an embodiment may also include one, two, four, or more battery modules 100.

Referring to FIGS. 2 to 4, the battery module 100 may include a plurality of sub-modules 101. The plurality of sub-modules 101 may include a first sub-module 101a and a second sub-module 101b. For example, the plurality of sub-modules 101 may be assembled along one direction (the X-axis direction in the drawing) to form a single battery module 100. However, the battery module 100 is not limited to this structure and may include three or more sub-modules 101. In the following description, the direction parallel to the direction in which the first sub-module 101a and the second sub-module 101b face each other is referred to as the first direction.

The first sub-module 101a and the second sub-module 101b included in the battery module 100 may have the same structure. For example, the plurality of sub-modules 101 of the same type may be manufactured and then assembled to form the entire battery module 100.

For example, in the following description, the first sub-module 101a and the second sub-module 101b merely refer to one and the other of the two assembled sub-modules 101, and both may be understood as sub-modules 101 having the same structure. Additionally, the sub-module 101 may be understood to mean either the first sub-module 101a or the second sub-module 101b described above. However, in the present disclosure, the first sub-module 101a and the second sub-module 101b are not limited to having the same structure.

The battery module 100 may include the top cover 170 that covers the plurality of sub-modules 101. The top cover 170 may have an area capable of covering the plurality of sub-modules 101 together. For example, the battery module 100 may cover the plurality of sub-modules 101 simultaneously with a single top cover 170.

The top cover 170 may include the boundary region 170c that covers between adjacent sub-modules 101. For example, the boundary region 170c may be defined as a region crossing between adjacent sub-modules 101. The boundary region 170c may have a predetermined width in a first direction (X-axis direction).

The top cover 170 additionally includes a first region 170a that covers the first sub-module 101a and a second region 170b that covers the second sub-module 101b. The boundary region 170c may be disposed between the first region 170a and the second region 170b.

In an example, the first region 170a, the second region 170b, and the boundary region 170c of the top cover 170 may be formed integrally. For example, a single, integrally-formed top cover 170 may be disposed to cover the upper surfaces of the plurality of sub-modules 101.

The battery module 100 may additionally include a bottom cover 160 that is located below the plurality of sub-modules 101 and supports the plurality of sub-modules 101. A single, integrally-formed bottom cover 160 may be disposed to cover the lower surfaces of the plurality of sub-modules 101.

However, the structure of the bottom cover 160 and/or the top cover 170 is not limited to the structure described above. For example, the bottom cover 160 and/or the top cover 170, which each cover the plurality of sub-modules 101, may be provided as multiple components, and the multiple components may be coupled together to form a single bottom cover 160 and/or top cover 170.

Each sub-module 101 may additionally include a cell assembly 110 including battery cells 111 stacked in one direction.

The cell assembly 110 may include a plurality of battery cells 111 stacked side by side. The stacking direction of the plurality of battery cells 111 and the direction in which the sub-modules 101 are disposed may be perpendicular to each other. For example, the sub-modules 101 may be disposed in a first direction (X-axis direction) on the upper surface of the bottom cover 160, and the battery cells 111 included in each sub-module 101 may be stacked in a second direction (e.g., Y-axis direction) perpendicular to the first direction (X-axis direction). In the following description, the “second direction” may be defined as the stacking direction of the battery cells 111.

The plurality of battery cells 111 may be configured to convert chemical energy into electrical energy and supply power to an external circuit, or to receive external power and convert electrical energy into chemical energy to store electricity. For example, the battery cells 111 may be configured as nickel-metal hydride (Ni-MH) batteries or lithium-ion (Li-ion) batteries capable of being charged and discharged.

Each of the plurality of battery cells 111 may include an electrode assembly including a cathode, an anode, and a separator. The electrode assembly may have a configuration in which the cathode and the anode are disposed with a separator therebetween so that wide surfaces thereof face each other. The separator may be configured to prevent electrical shorting between the cathode and the anode and to facilitate ion flow. For example, the separator may include a porous polymer film or a porous nonwoven fabric.

Additionally, the electrode assembly may be accommodated in the cell case in various ways, such as a stacking type, a jelly roll type formed by winding in a predetermined direction, a zigzag folding type, or a stack-folding type.

The plurality of battery cells 111 may be pouch-type, prismatic-type, or cylindrical-type secondary batteries, depending on the structure of the case. In an embodiment, each of the plurality of battery cells 111 is provided in a pouch shape, and the plurality of battery cells may be arranged side by side and connected to each other in series or parallel to form one cell assembly 110.

Each sub-module 101 may additionally include a protective cover 150 that protects the cell assembly 110. The protective cover 150 may include an end plate 151 and an inner plate 152 covering at least one side and the other side of the cell assembly 110, and a plurality of side plates 153.

The end plate 151 and the inner plate 152 may be spaced apart from each other in a first direction (X-axis direction), and a cell assembly 110 may be disposed between the end plate 151 and the inner plate 152. The end plate 151 may be disposed adjacent to the side where the terminal portion 123 is disposed in the sub-module 101. The inner plate 152 may be disposed adjacent to the side where the sensing terminal 130 is disposed in the sub-module 101. The sensing terminal 130 may transmit signals regarding the voltage and/or temperature of the sub-module 101 to the outside. The signals from the sensing terminal 130 may be transmitted to a battery management system (BMS) and/or a cell monitoring unit (CMU).

The side plate 153 is disposed to face the wide surface of the battery cell 111 and may protect the side surface of the cell assembly 110.

The end plate 151, inner plate 152, and side plate 153 may be formed of a material (for example, a metal material such as aluminum or SUS) sufficiently rigid to protect the sub-module 101 from external impact.

The side plate 153 may be connected to the end plate 151 and the inner plate 152, respectively. For example, a fastening member, such as a bolt, may penetrate the side plate 153 and be fastened to the end plate 151 and/or the inner plate 152. Alternatively, the side plate 153 may be mutually joined and fixed to the end plate 151 and/or the inner plate 152 without a separate fastening member. In this case, welding may be used as the joining method, but is not limited thereto.

Meanwhile, the side plate 153 may also be coupled to the busbar frame 122 disposed inside the end plate 151 and inner plate 152. The end plate 151, the inner plate 152, and the side plate 153 are firmly coupled to each other, thereby ensuring structural stability of the sub-module 101.

Each of the plurality of sub-modules 101 may include a cell assembly 110 in which a plurality of battery cells 111 are arranged, and a side plate 153 protecting the side surface of the cell assembly 110. The side plate 153 may include a module fastening portion 154 extending from the side surface of the side plate 153 and secured to the cross member 220.

The module fastening portion 154 may include a side extension portion 154a extending in the second direction (Y-axis direction) from the side surface of the side plate 153, and a fixing portion 154b formed on the side extension portion 154a. The side extension portion 154a is supported by the upper surface of the cross member 220, and the fixing portion 154b may be fixed to the cross member 220 using a fixing portion material such as a bolt (B in FIG. 8). Accordingly, the module fastening portion 154 may be fixed to the cross member 220.

The sub-module 101 may additionally include a busbar assembly 120 electrically connected to the cell assembly 110 and an insulating cover 140 coupled to the busbar assembly 120.

The busbar assembly 120 may include a busbar 121 including a plurality of conductive members electrically connected to the electrode leads 115 of the battery cell 111, and a busbar frame 122 supporting the busbar 121. Some of the plurality of busbars 121 may be connected to a terminal portion 123 that may be connected to an external electrical circuit. The terminal portion 123 may include a cathode terminal and an anode terminal.

Referring to FIG. 4, the busbar assembly 120 may include a first busbar assembly 120a disposed on one side of the cell assembly 110 and a second busbar assembly 120b disposed on the other side of the cell assembly 110. One of the first busbar assembly 120a and the second busbar assembly 120b may have a pair of terminal portions 123, while the other may not have a terminal portion 123. For example, the first busbar assembly 120a having a pair of terminal portions 123 may be disposed between the end plate 151 and the cell assembly 110, while the second busbar assembly 120b not having a terminal portion 123 may be disposed between the inner plate 152 and the cell assembly 110. The terminal portion 123 of the first busbar assembly 120a may be disposed adjacent to the end plate 151 and exposed to the outside of the battery module 100. The terminal portions 123 may be disposed spaced apart in the second direction (Y-axis direction) along one edge of the sub-module 101.

The insulating cover 140 may include a first insulating cover 141 and a second insulating cover 142. The first insulating cover 141 may be disposed between the first busbar assembly 120a and the end plate 151, thereby electrically insulating the first busbar assembly 120a from the end plate 151. The second insulating cover 142 may be disposed between the second busbar assembly 120b and the inner plate 152, thereby electrically insulating the second busbar assembly 120b from the inner plate 152.

The first insulating cover 141 and the second insulating cover 142 may be coupled to the first busbar assembly 120a and the second busbar assembly 120b, respectively. The first insulating cover 141 and the second insulating cover 142 may include an electrically insulating material to prevent the end plate 151 and the inner plate 152 from electrically shorting with the busbar 121.

The terminal portion 123 may be disposed adjacent to one edge of the sub-module 101. For example, the terminal portion 123 may be disposed on the first busbar assembly 120a between the end plate 151 and the cell assembly 110. For example, the terminal portion 123 included in each sub-module 101 may be disposed on the outer periphery of the battery module 100.

The first sub-module 101a and the second sub-module 101b may be assembled so that their inner plates 152 face each other.

While FIGS. 3 and 4 illustrate that the first sub-module 101a and the second sub-module 101b each include an inner plate 152, the present disclosure is not limited thereto. For example, the battery module 100 according to an embodiment may also have a structure in which a single inner plate 152 is disposed between the first sub-module 101a and the second sub-module 101b. When an inner plate 152 is disposed between the cell assembly 110 of the first sub-module 101a and the cell assembly 110 of the second sub-module 101b, the first sub-module 101a and the second sub-module 101b may share a single inner plate 152.

During the assembly process of the plurality of sub-modules 101, the side plates 153 included in respective sub-modules 101 may be joined to each other. For example, the side plate 153 of the first sub-module 101a and the side plate 153 of the second sub-module 101b may be joined to each other while facing each other in the first direction (X-axis direction). The side plate 153 of the first sub-module 101a and the side plate 153 of the second sub-module 101b may be joined by welding, but is not limited thereto.

The upper and lower portions of the first sub-module 101a and the second sub-module 101b may be covered by a top cover 170 and a bottom cover 160, respectively.

The bottom cover 160 may be coupled to the first sub-module 101a and the second sub-module 101b. For example, the first fastening member 161 may penetrate the bottom cover 160 and be fastened to the inner plate 152, thereby securing the first sub-module 101a and the second sub-module 101b to the bottom cover 160. Additionally, the second fastening member 162 may be fastened to the end plate 151 through the bottom cover 160.

The top cover 170 may be coupled to the first sub-module 101a and the second sub-module 101b. For example, the third fastening member 171 may be fastened to the inner plate 152 through the top cover 170, thereby securing the first sub-module 101a and the second sub-module 101b to the top cover 170. Additionally, the fourth fastening member 172 may be fastened to the end plate 151 through the top cover 170.

When the top cover 170 and bottom cover 160 are coupled to the sub-module 101, the end plate 151 of the sub-module 101 may be disposed adjacent to one edge of the top cover 170 and bottom cover 160. Additionally, the inner plate 152 may be disposed in the central region of the top cover 170 and bottom cover 160 in the first direction (X-axis direction).

The bottom cover 160 and the top cover 170 may be joined to the side plates 153 of the sub-module 101, respectively. For example, when the sub-module 101 is secured to the bottom cover 160, the side plate 153 may come into contact with the bottom cover 160 and may be joined together along the contacted portion. Similarly, when the top cover 170 is disposed above the sub-module 101, the side plate 153 may come into contact with the top cover 170 and be joined together along the contacted portion.

In this way, the top cover 170 and the bottom cover 160 may be coupled to the sub-module 101 to form the entire battery module 100.

In the battery module 100, the end plate 151 and the side plate 153 of each sub-module 101 may be exposed to the exterior of the battery module 100. For example, the upper surface of the battery module 100 may be formed by the top cover 170, the lower surface by the bottom cover 160, and the side surface by the end plate 151 and side plate 153. In this case, the inner plates 152 of respective sub-modules 101 face each other inside the battery module 100 and are covered by the top cover 170, bottom cover 160, and side plates 153 so as not to be exposed to the outside of the battery module 100.

In this way, the battery module 100 according to an embodiment may include a plurality of sub-modules 101. The plurality of sub-modules 101 may improve the efficiency and energy efficiency of the assembly process by simplifying the connection and assembly relationship between the sub-modules 101.

The pressing member 300 presses the upper portion of the top cover 170 and may be coupled to the pack housing 200. The pressing member 300 may be secured to the cross member 220 of the pack housing 200 while pressing the upper surface of the top cover 170 of the battery module 100.

The top cover 170 of the battery module 100 includes a boundary region 170c that covers between adjacent sub-modules 101, and the pressing member 300 may be disposed to pressurize the top cover 170 above the boundary region 170c. The pressing member 300 may prevent the spread of flames or gases between adjacent sub-modules 101.

The number of pressing members 300 may correspond to the number of respective battery modules 100, but is not limited thereto. For example, the top covers 170 of multiple battery modules 100 may also be pressurized with a single pressing member 300 (see FIG. 13).

FIG. 5 is a cross-sectional view taken along line I-I’ of FIG. 2.

Referring to FIG. 5, a battery module 100 may include a plurality of sub-modules 101, a top cover 170 covering the upper portions of the plurality of sub-modules 101, and a bottom cover 160 supporting the lower portions of the plurality of sub-modules 101. As an example, the plurality of sub-modules 101 may include a first sub-module 101a and a second sub-module 101b. The first sub-module 101a and the second sub-module 101b may each include a cell assembly 110, an end plate 151, and an inner plate 152. The inner plate 152 may be coupled to the bottom cover 160 via the first fastening member 161 and coupled to the top cover 170 via the third fastening member 171.

For example, if thermal runaway, which generates flame and/or gas, occurs in the cell assembly 110 provided in the first sub-module 101a, the pressure in the first sub-module 101a may increase, causing the flame and/or gas to propagate to the second sub-module 101b. In detail, if the pressure in the first sub-module 101a increases, the top cover 170 may lift upward, weakening the bond between the top cover 170 and the inner plate 152. For example, the top cover 170 and the inner plate 152 are coupled via a third fastening member 171. If the top cover 170 is lifted upward at the boundary region 170c due to an increase in the pressure of the sub-module 101, the fastening force of the third fastening member 171 may be weakened or the third fastening member 171 may be detached from the top cover 170. In this case, a space may be formed between the top cover 170 and the inner plate 152, and thus, a flame and/or gas generated in the first sub-module 101a may propagate to the second sub-module 101b through the space between the top cover 170 and the inner plate 152. Accordingly, thermal runaway may also occur in the second sub-module 101b. If thermal runaway occurs in one sub-module 101, the thermal runaway may also progress through the space between the bottom cover 160 and the inner plate 152.

The battery pack 10 according to an embodiment utilizes a pressing member (300 of FIG. 1) to pressurize the upper surface of the top cover 170 at the boundary region 170c located between the first region 170a and the second region 170b, thereby delaying or significantly reducing the propagation of thermal runaway occurring in the sub-module 101 to the adjacent sub-module 101. The detailed configuration of the pressing member 300 will be described below.

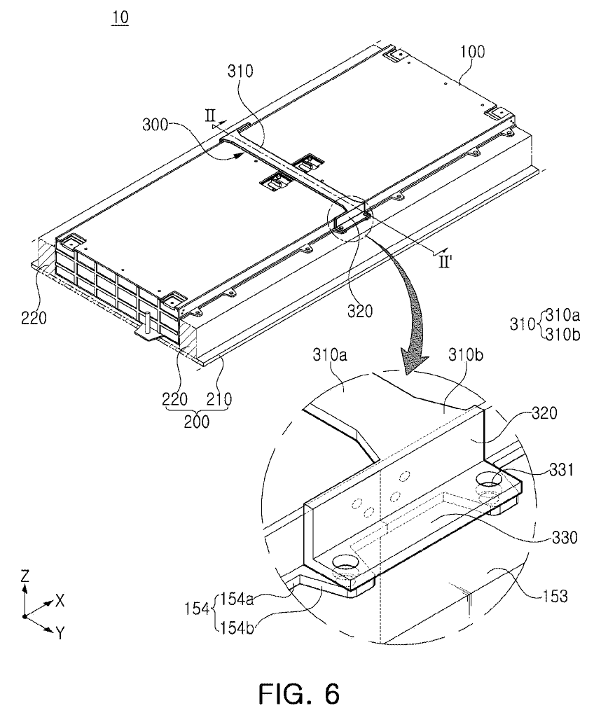

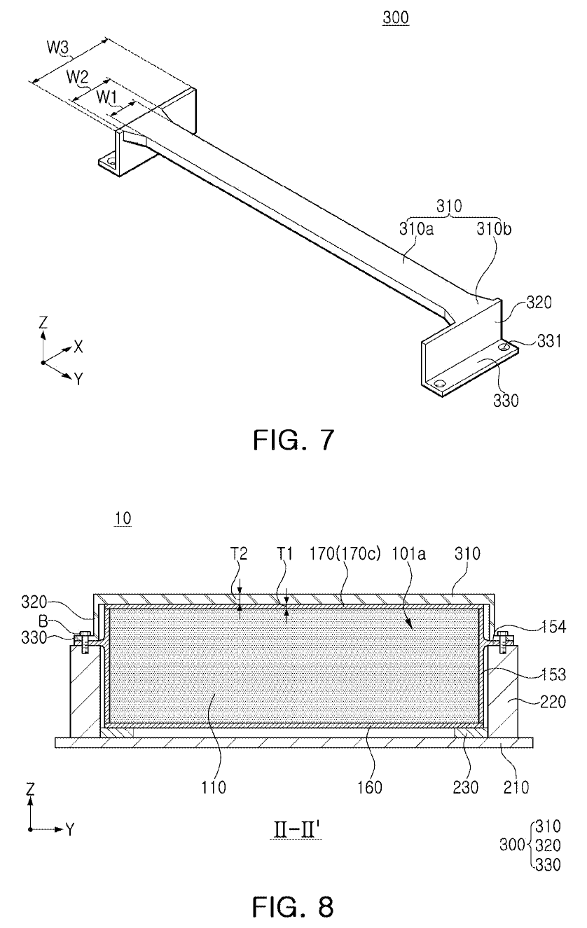

FIG. 6 is a perspective view illustrating a portion of a battery pack 10 according to an embodiment, FIG. 7 is a perspective view of the pressing member 300 according to an embodiment, and FIG. 8 is a cross-sectional view taken along line II-II’ of FIG. 6.

Referring to FIGS. 6 to 8, the pressing member 300 may pressurize the upper portion of the top cover 170. The pressing member 300 may be disposed to pressurize the top cover 170 above the boundary region 170c.

The pressing member 300 pressurizes the upper surface of the top cover 170 at the boundary region 170c of the top cover 170, thereby preventing the top cover 170 from lifting upwards from the boundary region 170c when thermal runaway occurs in the sub-module 101. Accordingly, the pressing member 300 may delay or significantly reduce the propagation of thermal runaway occurring in one sub-module 101 to an adjacent sub-module 101.

The pack housing 200 may include a base plate 210 supporting the lower portion of the battery module 100 and a cross member 220 disposed across the base plate 210. The pressing member 300 may be coupled to the cross member 220 of the pack housing 200.

The pressing member 300 may include a pressing portion 310 covering the top cover 170, an extension portion 320 bent from both ends of the pressing portion 310 and extending downward, and a support portion 330 connected to the extension portion 320 and supported by the cross member 220. The pressing portion 310 may cover the top cover 170 at a portion including the boundary region 170c of the top cover 170. The extension portion 320 extends downward from both ends of the pressing portion 310 and may connect the pressing portion 310 and the support portion 330.

The side plate 153 may include a module fastening portion 154 extending from the side surface of the side plate 153 and secured to the cross member 220. The module fastening portion 154 may include a side extension portion 154a extending in a second direction (Y-axis direction) from the side surface of the side plate 153 and a fixing portion 154b formed on the side extension portion 154a.

The support portion 330 of the pressing member 300 may be coupled to the cross member 220. The support portion 330 may be secured to the cross member 220 from the upper side of the module fastening portion 154.

The support portion 330 of the pressing member 300 may be secured to the cross member 220 of the pack housing 200 by a fixing portion material B. The support portion 330 may be secured to the cross member 220 by a fixing portion material B that penetrates the support portion 330 and the module fastening portion 154 and is then fastened to the cross member 220. The support portion 330 may include a fastening hole 331 through which the fixing portion material B passes.

A thickness T2 of the pressing member 300 may has a value greater than or equal to a thickness T1 of the top cover 170. When the thickness T2 of the pressing member 300 is thick, the rigidity of the pressing member 300 may be increased. Accordingly, when thermal runaway occurs in one sub-module 101, the pressing member 300 may limit deformation or lifting of the top cover 170.

For example, the thickness T2 of the pressing member 300 may be 1 or more, 1.5 or more, or 2 or more times the thickness T1 of the top cover 170. The thickness T2 of the pressing member 300 may be less than or equal to 5 times or 4 times the thickness T1 of the top cover 170. The pressing member 300 may have a thickness of 1 mm or more, 1.5 mm or more, or 2 mm or more. The pressing member 300 may have a thickness of 5 mm or less, or 4 mm or less.

For example, the pressing member 300 may include materials such as aluminum, steel, alloys containing these materials, or engineering plastics.

However, the thickness and material of the pressing member 300 are not limited to the aforementioned descriptions, and various modifications are possible as long as the pressing member has sufficient rigidity to prevent deformation or lifting of the top cover 170.

The pressing portion 310 may include a first portion disposed in the center of the pressing portion 310 and a second portion respectively disposed on both sides of the first portion and connected to the extension portion 320. A width W2 of the second portion may have a larger value than a width W1 of the first portion. If the width W2 of the second portion is larger than the width W1 of the first portion, a width W3 of the extension portion 320 connected to the second portion and the width of the support portion 330 connected to the extension portion 320 may also have a relatively large values.

The width W3 of the extension portion 320 may have a maximum value or more of the width of the pressing portion 310. For example, the extension portion 320 may have a value greater than the width W2 of the second portion. When the width W3 of the extension portion 320 and the width of the support portion 330 are large, the area of the portion where the support portion 330 is coupled to the cross member 220 may be increased. Accordingly, the pressing member 300 may be stably supported by the cross member 220.

However, the shape of the pressing member 300 is not limited to the aforementioned description, and various modifications are possible as long as it has sufficient rigidity to prevent deformation or lifting of the top cover 170.

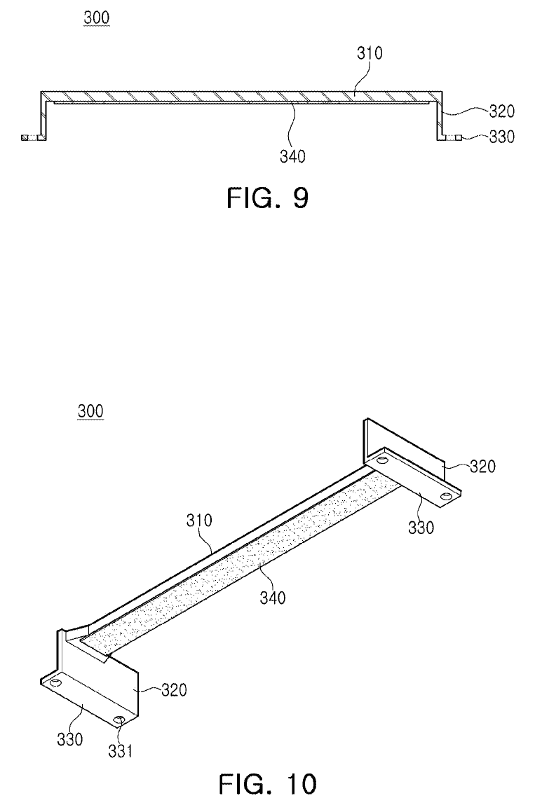

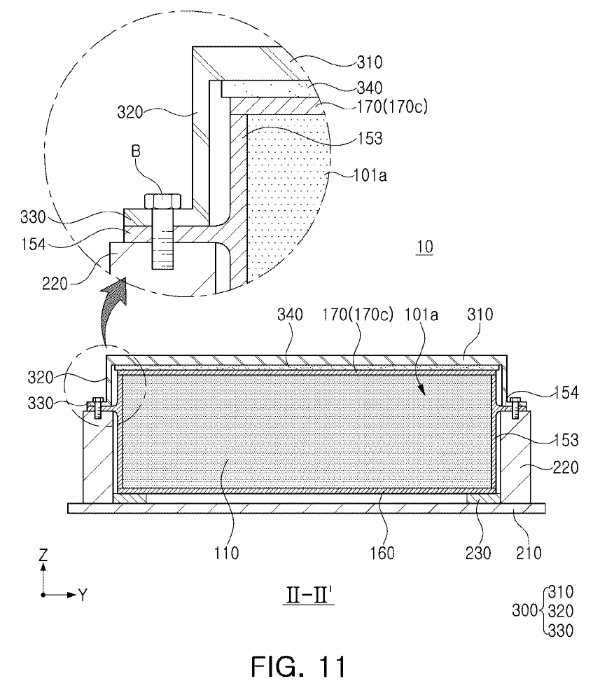

FIG. 9 is a cross-sectional view illustrating a modified embodiment of the pressing member 300. FIG. 10 is a perspective view of the pressing member 300 illustrated in FIG. 9 from below. FIG. 11 is a cross-sectional view illustrating the arrangement of the pressing member 300 illustrated in FIG. 9 along line II-II’ of FIG. 6.

Compared to the pressing member 300 illustrated in FIGS. 6 through 8, the modified embodiment of the pressing member 300 illustrated in FIGS. 9 through 11 differs in that it additionally includes a compressible member 340. The descriptions of the pressing member 300 and battery pack 10 illustrated in FIGS. 6 through 8, excluding any differences, also apply to FIGS. 9 through 11.

Referring to FIGS. 9 to 11, the pressing member 300 may include a pressing portion 310 positioned above the top cover 170 and a compressible member 340 attached to the lower side of the pressing portion 310 and containing a compressible material. The compressible member 340 may be compressed between the pressing portion 310 and the top cover 170.

If the pressing member 300 is positioned on an upper side of the top cover 170, a gap may be formed between the pressing member 300 and the top cover 170 due to tolerances or assembly steps. In this case, the pressing force of the pressing member 300 may not be sufficiently transmitted to the top cover 170. The compressible member 340 may be compressed between the pressing portion 310 of the pressing member 300 and the top cover 170, thereby filling the gap between the pressing member 300 and the top cover 170. Accordingly, the compressible member 340 may smoothly transmit the pressure of the pressing portion 310 to the top cover 170.

The compressible member 340 may be made of a compressible material. The compressible member 340 may include a flame-retardant material to withstand high temperatures. For example, the material of the compressible member 340 may include at least one of synthetic rubber, silicone, flame-retardant foam, aerogel foam, silica foam, and mica foam.

However, the material of the compressible member 340 is not limited to the aforementioned materials. Various modifications are possible, as long as it may be compressed between the pressing portion 310 of the pressing member 300 and the top cover 170 to fill the space between the pressing portion 310 and the top cover 170.

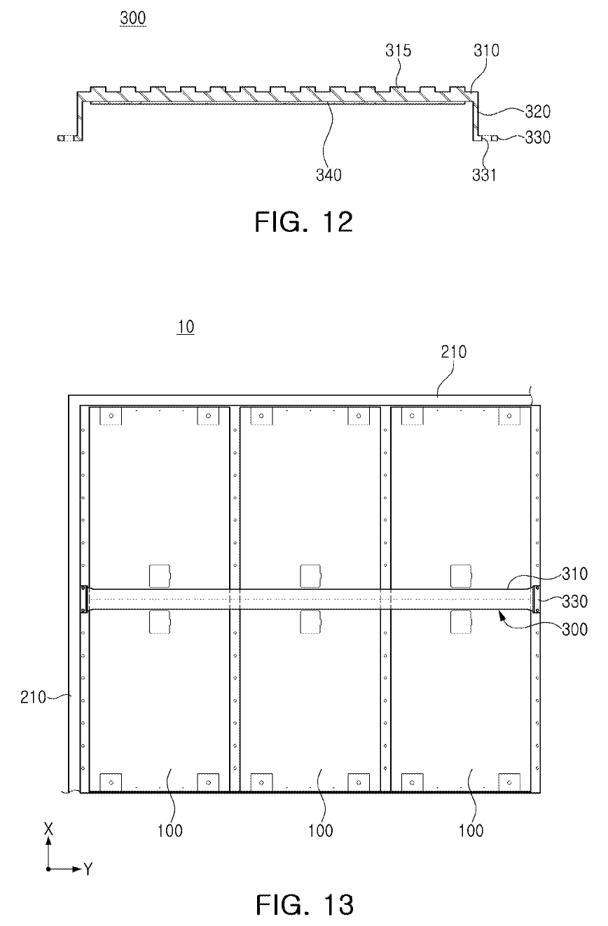

FIG. 12 is a cross-sectional view illustrating another modified embodiment of the pressing member 300.

Compared to the pressing member 300 illustrated in FIGS. 9 to 11, the pressing member 300 illustrated in FIG. 12 differs in that it additionally includes a rigid reinforcing structure 350. The descriptions of the pressing member 300 illustrated in FIGS. 9 to 11, excluding the differences, also apply to the pressing member 300 illustrated in FIG. 12.

The pressing member 300 may include a rigid reinforcing structure 350 with a concave-convex portion to increase the rigidity of the pressing member 300.

The rigid reinforcing structure 350 may be applied as a structure that reinforces the rigidity of the surface of the pressing member 300 through beading, roughening, or the like. The rigid reinforcing structure 350 may be formed on the surface of the pressing portion 310. In FIG. 12, the rigid reinforcing structure 350 is illustrated as having a shape in which a concave-convex structure is formed only on the upper side, but the concave-convex structure may also be formed on the upper and lower sides, respectively, or the thickness of the pressing portion 310 may also be configured to have a shape with a constant thickness.

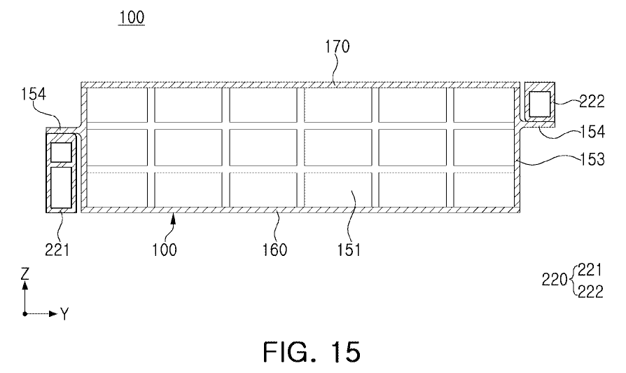

FIG. 13 is a plan view illustrating a portion of a battery pack 10 according to another embodiment, FIG. 14 is a front view illustrating the battery pack 10 of FIG. 13 from the front, and FIG. 15 is a schematic diagram illustrating an example of the battery module 100 illustrated in FIG. 13.

Compared to the battery pack 10 illustrated in FIGS. 1 to 8, the battery pack 10 illustrated in FIGS. 13 to 15 differs in that a pressing member 300 covers the top cover 170 of multiple battery modules 100, and the battery module 100 and cross member 220 of the pack housing 200 are positioned on the base plate 210 of the pack housing 200 while the cross member 220 is coupled to the battery module 100. The description of the battery pack 10 illustrated in FIGS. 1 through 8, excluding any differences, may also be applied to FIGS. 13 through 15.

The battery pack 10 may include a pack housing 200 and at least one battery module 100. Referring to FIGS. 13 through 15, at least one battery module 100 includes a plurality of battery modules 100, and a pressing member 300 may cover the top covers 170 provided in the plurality of battery modules 100 together. For example, one pressing member 300 may respectively cover the top covers 170 provided on the multiple battery modules 100. Covering multiple top covers 170 with a pressing member 300 may facilitate assembly of the pressing member 300.

Referring to FIGS. 13 to 15 along with FIGS. 2 to 4, the battery module 100 may include a plurality of sub-modules 101. Each of the plurality of sub-modules 101 may include a cell assembly 110 in which a plurality of battery cells 111 are arranged, and a side plate 153 protecting the side surfaces of the cell assemblies 110. The pack housing 200 may include a base plate 210 positioned beneath the multiple battery modules 100, a pack cover 230 covering the multiple battery modules 100, and a cross member 220 positioned between adjacent battery modules 100.

The cross member 220 may be positioned on the base plate 210 while being coupled to each battery module 100. If the cross member 220 is pre-attached to the base plate 210, assembly tolerances are required to dispose the battery module 100 in the space between the cross members 220, resulting in dead space in the pack housing 200, which may reduce the energy density of the battery pack 10. Conversely, if the cross member 220 is pre-attached to the battery module 100 and then disposed on the base plate 210 of the pack housing 200, the dead space between the battery module 100 and the cross member 220 may be reduced, thereby increasing the energy density of the battery pack 10.

The side plate 153 may include a module fastening portion 154 extending from the side surface of the side plate 153 and coupled to the cross member 220. The module fastening portion 154 may extend from the side plate 153 in a second direction (Y-axis direction) and be provided for connection with the cross member 220.

The cross member 220 may include a first cross member 221 positioned below the module fastening portion 154 to support the module fastening portion 154, and a second cross member 222 positioned above the module fastening portion 154.

Referring to FIG. 15, the first cross member 221 may be positioned opposite the side plate 153 located on a first side of each battery module 100. The second cross member 222 may be positioned opposite the side plate 153 located on a second side of each battery module 100.

For example, in one battery module 100, a first cross member 221 coupled to the lower side of the module fastening portion 154 may be disposed on a first side, and a second cross member 222 coupled to the upper side of the module fastening portion 154 may be disposed on a second side. The first cross member 221 and the module fastening portion 154 may be fixed by welding, bolting, or the like. Similarly, the second cross member 222 and the module fastening portion 154 may be fixed by welding, bolting, or the like.

Referring to FIG. 14, when a plurality of battery modules 100 are disposed in series, the module fastening portion 154 to which the second cross member 222 is fixed may be disposed on the upper side of the module fastening portion 154 of the adjacent battery module 100, and the module fastening portion 154 to which the first cross member 221 is fixed may be disposed on the lower side of the module fastening portion 154 of the adjacent battery module 100.

Between the pressing member 300 and the base plate 210, a second cross member 222, a module fastening portion 154, and a first cross member 221 may be vertically disposed. The pressing member 300 may be structured to press (or pressurize) the second cross member 222 between adjacent battery modules 100.

For example, in the space between the pressing member 300 and the base plate 210, it may be configured in such a manner that the second cross member 222 and the module fastening portion 154 contact each other, the module fastening portion 154 contacts the first cross member 221, and the first cross member 221 contacts the base plate 210. In this case, the pressing force exerted by the pressing member 300 may be applied vertically between the second cross member 222, the module fastening portion 154, and the first cross member 221.

However, the structure in which the cross member 220 is coupled to the battery module 100 may be changed in various ways. For example, in FIGS. 14 and 15, the module fastening portion 154 is shown as being formed on both the side plates 153 located on the first side and the second side of the battery module 100, but the module fastening portion 154 may also be positioned only on the side plate 153 located on either the first side or the second side. For example, when the module fastening portion 154 is not provided on the first side of the battery module 100, the first cross member 221 may be directly coupled to the side plate 153.

As set forth above, according to an embodiment, the spread of a thermal runaway occurring in a sub-module including a plurality of battery cells to adjacent sub-modules may be delayed or significantly reduced.

According to an embodiment, the spread of a fire occurring in one battery module to adjacent battery modules may be delayed or significantly reduced.

Only specific examples of implementations of certain embodiments are described. Variations, improvements and enhancements of the disclosed embodiments and other embodiments may be made based on the disclosure of this patent document. Therefore, the above description is merely an example of applying the principles of the present disclosure, and other configurations may be included without departing from the scope of the present disclosure. Furthermore, some components of the above-described embodiments may be omitted, and the embodiments may be combined with each other.

What is claimed is:

1. A battery pack comprising:
at least one battery module including a plurality of sub-modules and a top cover covering the plurality of sub-modules, the plurality of sub-modules each including a plurality of battery cells;
a pack housing in which the at least one battery module is installed; and
a pressing member pressing an upper portion of the top cover and coupled to the pack housing,
wherein the top cover includes a boundary region covering a gap between adjacent sub-modules, and
the pressing member is structured to press the top cover above the boundary region.

2. The battery pack of claim 1, wherein the top cover has an area capable of covering the plurality of sub-modules together.

3. The battery pack of claim 1, wherein the plurality of sub-modules include a first sub-module and a second sub-module,
the top cover further includes a first region covering the first sub-module and a second region covering the second sub-module, and
the boundary region is located between the first region and the second region.

4. The battery pack of claim 3, wherein the first region, the second region, and the boundary region of the pressing member are formed integrally.

5. The battery pack of claim 1, wherein the pack housing includes a base plate disposed below the at least one battery module, and a cross member disposed opposite a side surface of the at least one battery module, and
the pressing member is coupled to the cross member.

6. The battery pack of claim 5, wherein the pressing member includes a pressing portion covering the top cover, an extension portion bent from both ends of the pressing portion and extending downward, and a support portion connected to the extension portion and supported by the cross member.

7. The battery pack of claim 6, wherein each of the plurality of sub-modules includes a cell assembly in which a plurality of battery cells are arranged, and a side plate protecting a side surface of the cell assembly,
wherein the side plate includes a module fastening portion extending from a side surface of the side plate and fixed to the cross member, and
the support portion is fixed to the cross member above the module fastening portion.

8. The battery pack of claim 7, wherein the support portion is fixed to the cross member by a fixing member that penetrates the support portion and the module fastening portion and is then fastened to the cross member.

9. The battery pack of claim 6, wherein a width of the extension portion has a value greater than or equal to a maximum value of a width of the pressing portion.

10. The battery pack of claim 6, wherein the pressing portion includes a first portion located at a center of the pressing portion and a second portion respectively located on both sides of the first portion and connected to the extension portion,
wherein a width of the second portion has a value greater than a width of the first portion.

11. The battery pack of claim 1, wherein a thickness of the pressing member has a value greater than or equal to a thickness of the top cover.

12. The battery pack of claim 1, wherein the pressing member includes a pressing portion disposed above the top cover, and a compressible member attached to a lower side of the pressing portion and including a compressible material,
wherein the compressible member is compressed between the pressing portion and the top cover.

13. The battery pack of claim 12, wherein a material of the compressible member includes at least one of synthetic rubber, silicone, flame-retardant foam, aerogel foam, silica foam, or mica foam.

14. The battery pack of claim 1, wherein the pressing member includes a rigid reinforcing structure having a concave-convex portion to increase rigidity of the pressing member.

15. The battery pack of claim 1, wherein the at least one battery module includes a plurality of battery modules, and
the pressing member covers top covers provided in the plurality of battery modules together.

16. The battery pack of claim 15, wherein each of the plurality of sub-modules includes a cell assembly in which a plurality of battery cells are arranged and a side plate protecting a side surface of the cell assembly, and
the pack housing includes a base plate disposed below the plurality of battery modules, a pack cover covering the plurality of battery modules, and a cross member disposed between adjacent battery modules,
wherein the cross member is disposed on the base plate while being coupled to each battery module.

17. The battery pack of claim 16, wherein the side plate includes a module fastening portion extending from a side surface of the side plate and coupled to the cross member, and
the cross member includes a first cross member disposed below the module fastening portion and supporting the module fastening portion, and a second cross member disposed above the module fastening portion.

18. The battery pack of claim 17, wherein the first cross member is disposed opposite a side plate positioned on a first side of each battery module, and
the second cross member is disposed opposite a side plate positioned on a second side of each battery module.

19. The battery pack of claim 17, wherein the second cross member, the module fastening portion, and the first cross member are disposed vertically between the pressing member and the base plate, and
the pressing member is structured to press the second cross member, between adjacent battery modules.

20. A battery pack comprising:
at least one battery module including a first sub-module and a second sub-module each including a plurality of battery cells, and a top cover covering the first sub-module and the second sub-module together;
a pack housing in which the at least one battery module is installed; and
a pressing member pressing an upper portion of the top cover and coupled to the pack housing,
wherein the top cover includes a first region covering the first sub-module and a second region covering the second sub-module, and
the pressing member is located in a position transversing a space between the first region and the second region and presses the top cover.
